(19) United States
(12) Patent Application Publication
(10) Pub. No.: US 2008/0196805 A1
(43) Pub. Date: Aug. 21, 2008

(54) No-flat tire

(76) Inventor: Danny Towns, Columbus, OH (US)

Correspondence Address: Danny TOWNS, 2223 Jermain Dr., Columbus, OH, 43211, US

(21) Appl. No.: 11/706,175

(22) Filed: Feb. 15, 2007

(51) Int. Cl. B60C 7/00

(52) U.S. Cl. 152/158

(57) ABSTRACT

An insert for a conventional tire. The insert includes a doughnut-shaped piece of material shaped and sized to fit inside the tire and to contact an inside surface of the tire's tread during normal driving (i.e., when driving without a flat). In preferred embodiments, the doughnut-shaped piece of material can be sized to contact an entire surface of the tire or to contact an entire inside surface of the tire's tread. Different sized inserts can be used with different sized tires. The insert also includes one or more (preferably about eight) mounting or insert brackets attached to the rim to support the doughnut-shaped piece of material. These brackets can facilitate use of the insert with various different types and shapes of rims. Also, methods of installing and using the insert.

### BACKGROUND OF THE INVENTION

1. Field of the Invention

This invention relates to an insert for a tire that makes the tire resistant to going flat.

2. Description of the Related Art

Flat tires are extremely inconvenient and sometimes dangerous. For example, if a vehicle's tire goes flat when on a freeway, the vehicle might be thrown out of control. This can result in injury or even death.

“Run flat” tires are one attempt to address this problem. However, run-flat tires do not actually prevent flat tires. Rather, they simply allow a driver to maintain some control and to drive a limited distance before a flat tire must be changed.

One type of tire that cannot go flat includes solid rubber tires such as those used in some military applications. However, these tires tend to provide a very unsatisfactory ride. In addition, this type of tire cannot be used in conjunction with conventional tires, but rather are used instead of conventional tires. This limits the range of applicability of the tires.

### SUMMARY OF THE INVENTION

Accordingly, what is needed is an insert that can be used with conventional tires to make the tires resistant to flats.

The invention addresses this need with an insert for a conventional tire. The insert includes a doughnut-shaped piece of material shaped and sized to fit inside the tire and to contact an inside surface of the tire's tread during normal driving (i.e., when driving without a flat). In preferred embodiments, the doughnut-shaped piece of material can be sized to contact an entire surface of the tire or to contact an entire inside surface of the tire's tread. Different sized inserts can be used with different sized tires. The insert also includes one or more (preferably about eight) mounting or insert brackets attached to the rim to support the doughnut-shaped piece of material. These brackets facilitate use of the insert with various different types and shapes of rims.

The insert supports the tire away from the rim with little or even no air pressure (above atmospheric pressure) inside the tire. The material of the insert will not “leak” out of the tire even if the tire has a substantial puncture or tear. Thus, the tire will not go flat in most circumstances. In fact, a tire with the insert in place should be resistant to anything short of massive damage to the tire.

The doughnut-shaped piece of material can be made of natural rubber, synthetic rubber, natural resin, synthetic resin, fabric (e.g., Kevlar®), plastic, or other materials. The material can be porous (i.e., with air pockets inside) or non-porous. However, the most preferred embodiment uses solely solid rubber.

The doughnut-shaped piece of material will be a single piece of material.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a view of a tire and rim with an insert according to the invention installed.

FIG. 2 shows a perspective view of a doughnut-shaped piece of material for the insert shown in FIG. 1.

FIG. 3 shows a sectional view of the doughnut-shaped piece of material shown in FIG. 2.

FIG. 4 shows mounting or insert brackets attached to a rim to support an insert according to the invention.

### DESCRIPTION OF THE PREFERRED EMBODIMENT

Briefly, one aspect of the invention is an insert for a conventional tire. The insert include a doughnut-shaped piece of material shaped and sized to fit inside the tire and to contact an inside surface of the tire's tread during normal driving (i.e., when driving without a flat). The insert also includes one or more mounting or insert brackets attached to the rim to support the doughnut-shaped piece of material.

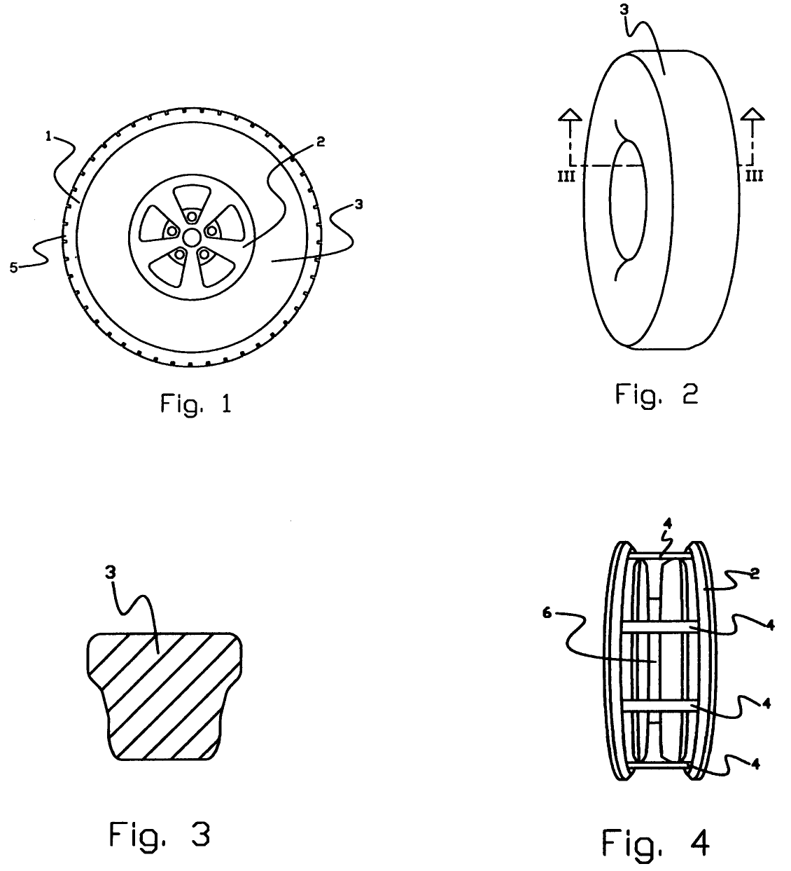

FIG. 1 shows a view of a tire and rim with an insert according to the invention installed. In more detail, FIG. 1 shows a cut-away view of tire 1 on rim 2. Doughnut-shaped piece of material 3 spans the space between tire 1 and mounting or insert brackets 4 on rim 2. FIG. 2 shows a perspective view of material 3, and FIG. 3 shows a sectional view along line III-III in FIG. 2.

The doughnut-shaped piece of material preferably is shaped and sized to contact an entire surface of the tire's tread 5, although this need not be the case. In addition, the material can be shaped and sized to contact an entire inside surface of the tire. For example, the cross-section shown in FIG. 3 of insert 3 matches the inside surface of a tire with which the insert is intended to be used. Other shaped and sized designs can be used as long as the insert contacts at least enough of the inside surface of the tire's tread to support the tire during driving.

The doughnut-shaped piece of material can be made of natural or synthetic rubber as indicated by the hashing in FIG. 3. Alternatively, the insert can be made of natural resin, synthetic resin, fabric (e.g., Kevlar®), plastic, other materials, or some combination of these materials. The material can be porous (i.e., with air pockets inside) or non-porous. However, the most preferred embodiment uses solely solid rubber.

Different shapes and size of material preferably are used with different shaped and sized tires.

FIG. 4 shows more detail of brackets 4 attached to rim 2. The brackets can be attached using any suitable technique. One suitable technique is to attach the brackets in a same manner as wheel weights are attached to a rim.

The brackets support an insert, according to the invention, above a drop center 6 of the rim 2. The brackets 4 facilitate use of a standard sized doughnut-shaped piece of material with various different types of rims that have different drop centers. Thus, even if another rim has a differently shaped drop center than rim 2 in FIG. 4, a same shaped insert can be used in both cases as long as the rims are for a same sized tire by virtue of use of the brackets.

In addition, same sized brackets often can be used with differently sized rims. As is evident from FIG. 4, attachment of the brackets is not dependent upon a radius of the rim.

Preferably, the brackets are about one inch wide and are made of metal alloy. Any other suitably strong and durable material can be used. In addition, different sized brackets also can be used.

Eight mounting brackets preferably are used. Fewer or more brackets can be used if so desired. In one alternative embodiment, a single bracket that completely surrounds the drop center is used. In another alternative embodiment, more than eight brackets are used, for example, to provide extra support.

An insert, according to the invention, (including a doughnut-shaped piece of material and brackets) supports the tire away from the rim with little or even no air inside the tire. The material of the insert does not “leak” out of a tire even if the tire has a substantial puncture or cut. Thus, the tire will not go flat in most circumstances. In fact, a tire with the insert in place should be resistant to anything short of massive damage to the tire.

### ALTERNATIVE EMBODIMENTS

In the preceding description, a preferred embodiment of the invention is described with regard to preferred process steps and data structures. The invention is in no way limited to the specifics of any particular preferred embodiment disclosed herein. Many variations are possible which remain within the content, scope and spirit of the invention, and these variations would become clear to those skilled in the art after perusal of this application.

What is claimed is:

1. An insert for a conventional tire comprising a doughnut-shaped piece of material shaped and sized to fit inside the tire and to contact an inside surface of the tire's tread; and one or more mounting or insert brackets attached to a rim for the tire to support the doughnut-shaped piece of material.

2. An insert as in claim 1, wherein the doughnut-shaped piece of material is sized to contact an entire inside surface of the tire's tread.

3. An insert as in claim 1, wherein the doughnut-shaped piece of material is sized to contact an entire inside surface of the tire.

4. An insert as in claim 1, wherein the doughnut-shaped piece of material is made of natural rubber, synthetic rubber, natural resin, synthetic resin, fabric or plastic.

5. An insert as in claim 1, wherein the doughnut-shaped piece of material is made solely of solid rubber.

6. A method of placing an insert in a conventional tire, the insert comprising a doughnut-shaped piece of material shaped and sized to fit inside the tire and to contact an inside surface of the tire's tread and one or more mounting or insert brackets attached to a rim for the tire to support the doughnut-shaped piece of material comprising the steps of:
taking the tire off a rim;
placing the doughnut-shaped piece of material inside the tire;
attaching insert or mounting brackets to the rim; and,
placing the tire with the doughnut-shaped piece of material back on the rim with the insert or mounting brackets.

7. A method as in claim 6, wherein the doughnut-shaped piece of material is sized to contact an entire inside surface of the tire's tread.

8. A method as in claim 6, wherein the doughnut-shaped piece of material is sized to contact an entire inside surface of the tire.

9. A method as in claim 6, wherein the doughnut-shaped piece of material is made of natural rubber, synthetic rubber, natural resin, synthetic resin, fabric or plastic.

10. A method as in claim 6, wherein the doughnut-shaped piece of material is made solely of solid rubber.
